(19) United States
(12) Patent Application Publication
(10) Pub. No.: US 2012/0166458 A1
(43) Pub. Date: Jun. 28, 2012

(54) SPAM TRACKING ANALYSIS REPORTING SYSTEM

(75) Inventors: Paul Laudanski, Duvall, WA (US); Cynthia Lilly, Olympia, WA (US); Ivan Osipkov, Bellevue, WA (US); Ravi Shankar Srikantasarma, Bellevue, WA (US); Ramesh Munusamy, Bangalore (IN); David Anselmi, Bothell, WA (US)

(73) Assignee: MICROSOFT CORPORATION, Redmond, WA (US)

(21) Appl. No.: 12/978,295

(22) Filed: Dec. 23, 2010

(51) Int. Cl. G06F 17/30

(52) U.S. Cl. 707/755; 707/E17.044

(57) ABSTRACT

The subject application describes systems and/or methods for spam and uniform resource locator (URL) analysis reporting. The system can include components for: processing raw data associated with spam and/or URL tracking and reporting, parsing the raw data into a plurality of data elements, capturing and persisting internal and/or external information and associations about a data element included in the plurality of data elements, based on the captured or persisted internal and/or external information, building a digital trail associated with disparate data elements; and performing advanced intelligence on the disparate data elements.

### BACKGROUND

The advent of global communications networks, such as the Internet, has presented commercial opportunities for reaching vast numbers of potential customers. Electronic messaging, and particularly electronic mail (“e-mail), is a pervasive means for disseminating unsolicited, undesired bulk messages (spam) to network users including advertisements and promotions, for example.

Despite many efforts with respect to reduction and prevention, spam continues to be a major problem. According to industry estimates, billions of e-mail messages are sent each day and over seventy percent can be attributed to spam. Individuals and entities (e.g., businesses, government agencies, etc.) are being increasingly inconvenienced by these unwanted messages. Moreover, since received spam can include seemingly innocuous uniform resource locators (URLs) that point to purportedly legitimate websites, all manner of malicious software can inadvertently be accessed, downloaded, and installed on computers, which can cause of countless security issues, such as compromise of personal information, such as passwords, personal identification numbers (PINs), social security information, bank account and credit card details, and the like.

The tracking of disseminators of spam can be onerous, as spammers, in order to escape detection and to profit from their activities to the fullest, typically take cover behind multiple legitimate and/or illegitimate affiliates using uniform resource locator (URL) redirects, proxy services, and the like. Thus, spammers have been able to operate with impunity, carrying on their activities without necessarily facing the full legal ramifications and financial consequences of their actions.

The inability to bring spammers to heel has been due, for the most part, to the fact that the detection and/or tracking of spamming activity is spread over multiple detection and tracking facilities that typically do not interact or cooperate with one another. Thus, while one facility can have accumulated extensive intelligence regarding spamming activities associated with a particular spammer and another facility can have extensive databases detailing further disparate spamming activities carried out by the same spammer, the fact that neither facility has shared its resources with one another has meant that tracking spamming activity, locating web sites associated with spam and malware, and causing spammers to cease their operations has been an arduous and generally unrewarding activity.

The above description of the lack of effective spam tracking today is merely intended to provide an overview of today's deficiencies, and is not intended to be exhaustive. Other problems of the state of the art and corresponding benefits of the various non-limiting embodiments described herein may become further apparent upon review of the following description.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

In one or more embodiments the subject application discloses a method for spam and uniform resource locator (URL) analysis reporting. The method comprises processing raw data associated with spam and/or URL tracking and reporting, parsing the raw data into a plurality of data elements, capturing and persisting internal and/or external information about a data element included in the plurality of data elements, based at least in part on the captured or persisted internal and/or external information, building a digital trail associated with disparate data elements, and performing advanced intelligence on the disparate data elements.

In accordance with one or more further embodiments, the subject application discloses a system that comprises an analysis engine that parses and tokenizes raw data into a plurality of data elements, wherein the analysis engine employs the plurality of data elements to capture internal and/or external information about a data element included in the plurality of data elements, and builds a digital trail to an origination point of an e-mail included in the raw data based on the internal or external information.

In accordance with yet further embodiments, the subject application discloses a system, comprising an analysis engine that builds a digital trail based on internal and/or external information associated with a plurality of data elements parsed and tokenized from raw data that includes archival files, e-mail files, or text files, wherein the digital trail leads to an origination point associated with the plurality of data elements.

To the accomplishment of the foregoing and related ends, certain illustrative aspects of the disclosed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 is a block diagram depicting a system that effectuates spam tracking analysis reporting.

FIG. 2 provides further illustration of an analysis engine, and more particularly, a file handling component and a service component included with analysis engine.

FIG. 3 provides further depiction of a file handling component in accordance with various embodiments of the application.

FIG. 4 is a block diagram that further illustrates aspects of a service component in accordance with various described embodiments.

FIG. 5 shows analysis engine in additional detail and in accordance with various embodiments of the application.

FIG. 6 illustrates a flow diagram of a machine or computer implemented method that effectuates and/or facilitates spam and uniform resource locator (URL) analysis reporting.

FIG. 7 illustrates a further flow diagram of a machine or computer implemented method that effectuates and/or facilitates spam and uniform resource locator (URL) analysis reporting.

FIG. 8 is a further block diagram depicting a system that effectuates spam tracking analysis reporting.

FIG. 9 provides depiction of an illustrative digital trail built by the spam tracking analysis reporting system.

FIG. 10 is a further illustration of a digital trail generated by the spam tracking analysis reporting system.

FIG. 11 illustrates a block diagram of a computer operable to execute the disclosed system in accordance with an aspect of the disclosed subject matter.

FIG. 12 illustrates a schematic block diagram of an illustrative computing environment for processing the disclosed architecture in accordance with another aspect.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding thereof. It may be evident, however, that one or more embodiments can be practiced without these specific details. In other instances, well-known structures and devices are shown in block diagram form in order to facilitate a description thereof.

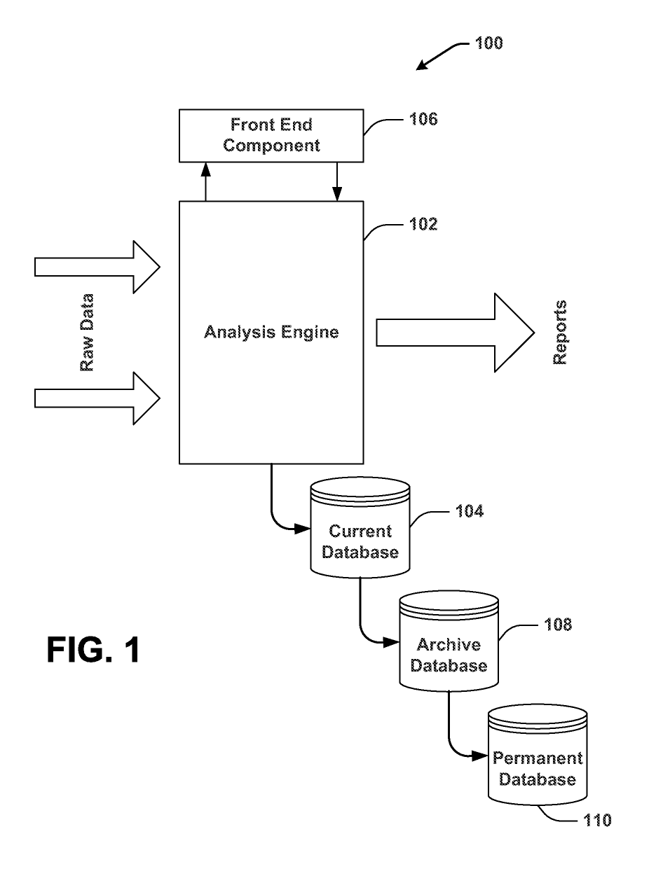

FIG. 1 is a block diagram depicting a system 100 that effectuates spam tracking analysis reporting in accordance with various embodiments. System 100 can include an analysis engine 102 that can directly receive raw data comprising multiple input streams that can include a whole gamut or array of data associated with domains, internet protocol (IP) addresses, universal resource identifiers (URIs) or universal resource locators (URLs), electronic mail (e-mail), geographical location to IP (GeoIP) address information, and the like. The received raw data can typically be associated with e-mails containing malware, spam, or rogue security software, or websites propagating malware, spam, rogue security software, etc. received through e-mails (solicited or unsolicited). Thus, in one or more embodiments, analysis engine 102 can receive and/or process e-mails emanating from multiple steams of raw input feed data, and can parse the raw input feed data into a plurality of data elements. The plurality of data elements can, for example, be extracted from header and body information associated with e-mails received in the streams of raw feed data. The plurality of data elements can thereafter be persisted to current database 104 for future processing or can both be persisted to current database 104 and contemporaneously processed by analysis engine 102 to derive or elicit, possibly in conjunction with previously persisted or subsequently acquired data elements, additional information regarding the extracted data elements. Based at least in part on the plurality of data elements and/or additional information, analysis engine 102 can thereafter build or create a digital trail linking the various data elements to provide an end-to-end path between a received e-mail (e.g., containing spam in the form of an illicit pharmacy advertisement) to the source from where a spam e-mail emanated. This digital trail can then be stored in current data base 104 for use by law enforcement officials in bringing purveyors of malware, spam, rogue security software, and the like, to justice.

It should be noted, without limitation loss of generality, in the context of building or creating a digital trail that traces the end-to-end path between a received e-mail containing spam and the source attribution from where the spam e-mail emanated, analysis engine 102 can utilize previously persisted end-to-end paths that hitherto may have been incomplete or partial end-to-end paths (e.g., previously persisted end-to-end paths commencing with a e-mail that might not have in the past yielded an appropriate destination containing malware, spam, rogue security software, etc.) and can sew or join these previously persisted end-to-end paths with newly created or recently revealed end-to-end paths to arrive at or converge on a destination containing malware, spam, rogue security software, etc.

At a general level, analysis engine 102 can automatically read and/or process raw data continuously fed into it from an external source. Further, analysis engine 102 can also receive and read (e.g., through facilities provided by front end component 106) and process lists of raw data manually supplied by users (e.g., privileged users, administrators, and so forth) of system 100. Additionally, analysis engine 102 can read and process data retrieved from current database 104 and/or archive database 108. Moreover, analysis engine 102 can monitor folders and subfolders created in current database 104 and/or archive database 108 for addition of new files or folders and thereafter can retrieve these new files or folders for further processing and/or analysis. Furthermore, analysis engine 102 can also monitor locations indicated by URLs included in the incoming raw data.

Further, analysis engine 102 can include tunable parameters that can be adjusted periodically in order to modify operation of analysis engine 102 to attain optimal levels of processing and/or analysis for continuously received or directly supplied raw data and/or manually supplied lists input through front end component 106. Tunable or adjustable parameters can include intervals during which analysis engine 102 will look for new raw data feeds, periods during which analysis engine 102 will look for manually supplied lists, thread sizes that analysis engine 102 will utilize in processing and/or analyzing raw data feeds and/or manually supplied lists, and the like.

Additionally, analysis engine 102 can include a monitoring service that regularly and/or continuously checks performance of analysis engine 102 and restarts analysis engine 102 when it stops for any reason. The monitoring service associated with analysis engine 102 can also be utilized to validate product keys for expiration of duration on startup or restart of analysis engine 102 and/or periodically check if stop processing instructions have been received from a privileged user, whereupon the instructions necessary to cease processing can be instituted.

In addition to input directly received by way of multiple feeds containing raw data, analysis engine 102 can be in communication with front end component 106 that can provide an interface for the introduction of individual queries, lists of queries, free text, or files into analysis engine 102 for processing and/or analysis. In accordance with this aspect, a privileged user (e.g., administrator, law-enforcement personnel, etc.) can submit jobs for processing through front end component 106. Typically each job can be a set of files or free text pasted by the user into a text window supplied by front end component 106 for this purpose. The set of files or free text can include URLs, e-mail identifiers, domains, and the like, which analysis engine 102 can process and/or analyze. Generally when utilizing this aspect, the privileged user may, for example, have recently been made aware of an incipient spam attack and as such may wish to see whether a trend can be discerned in relation to other information that might have previously been analyzed and/or persisted by analysis engine 102 or that is currently being analyzed and/or persisted by analysis engine 102.

With respect to manually inputting or submitting jobs via front end component 106 to analysis engine 102 for processing, it will be noted that these manually submitted jobs can be prioritized so that they can take precedence over raw data received by way of the multiple feeds. In order to afford users (e.g., privileged users, ordinary users, administrators, etc.) the ability to input or submit jobs to analysis engine 102, front end component 106 can be configured to allow users to select files based at least in part on file extensions or file handling types currently extant in the system and/or capable of being processed by analysis engine 102. Thus, in accordance with an embodiment, where analysis engine 102 has been configured to process e-mails (e.g., files with “.msg” extensions), front end component 106 can provide users the ability to manually input or submit such files. Similarly, in a further embodiment where analysis engine 102 has been configured and/or is capable of processing multiple e-mails aggregated into archival files (e.g., files with “.zip”, “.tar”, extensions), front end component 106 can provide users the facility to manually submit or input archival files. In yet a further embodiment where analysis engine 102 has been configured to process text files (e.g., files with “.txt” extensions), front end component 106 can be designed to permit users to enter such input. Additionally, in still a further embodiment, front end component 106 can provide a text box, for example, that can be utilized by users to enter free text that can subsequently be processed and/or analyzed by analysis engine 102.

In relation to manually entered raw data input through front end component 106 into analysis engine 102, when a user submits text and/or list of URLs, front end component 106 can make available to the user the following additional processing options. In accordance with various embodiments, front end component 106 can provide a check box or radio button to indicate whether or not a web crawl should be effectuated by analysis engine 102 (or associated components of analysis engine 102). Should the user desire that a web crawl be performed by analysis engine 102, front end component 106 can also solicit from the user the crawl level that should be performed (e.g., how deep the analysis engine 102 should recursively pursue URLs when visiting websites) wherein the crawl level by default is typically set to one. A default crawl level of one generally indicates that analysis engine 102 should browse or visit the URLs found on a web page. A crawl level of two, in contrast, indicates that analysis engine 102 should not confine itself to browsing or visiting the URLs identified on a particular web page, but should further browse or visit any URLs found on the web pages visited in a level one web crawl.

Further, in relation to manually entered raw data input through front end component 106 into analysis engine 102, it will be noted without limitation or loss of generality, that there can be a persisted white list of URLs that analysis engine 102 can consult prior to browsing or visiting manually specified URLs. The white list of URLs can be URLs that analysis engine 102 need not visit for various policy reasons, since typically it has previously been ascertained that URLs appearing in the white list have been deemed to be free of malware, rogue security software, and the like. Additionally and/or alternatively, the white list of URLs can be lists of URLs that analysis engine 102 will typically not action regardless of whether or not the content pointed to by the URLs has previously been established as being free of malware, rogue security software, and the like.

It will be noted in the context of the raw data feeds being continuously, automatically and/or directly supplied to analysis engine 102, that while the foregoing discussion focuses on e-mail, other tenable data feeds can also be processed by analysis engine 102. Examples of such data feeds can include archival files (e.g., files with .zip file extensions) containing multiple e-mails (or .msg files), free text supplied by a privileged user or administrator of system 100, sets of URLs wherein each URL within a set of URLs is formatted one URL per-line or is otherwise delimiter separated (e.g., separated with a comma, colon, semi-colon, vertical bar, or some other delimiting character). As can be readily appreciated, the raw data feeds directly supplied to analysis engine 102 can be in the form of file folders which can be an aggregate of any number of e-mails, or archival files containing multiple e-mails. Moreover, the file folders themselves can include multiple subfolders.

Additionally, it will be noted without limitation or loss of generality, in the context of the raw feeds being directly supplied to analysis engine 102, that these feeds can generally be processed in parallel, allowing new files or file formats to be added to analysis engine 102 dynamically and without interruption (e.g., without the need to stop or restart the system) to any processing that analysis engine 102 may currently be carrying out. Moreover, it will also be appreciated that system 100 is sufficiently flexible to be able to seamlessly handle additional new file formats without deleteriously affecting the functionality of the existing system.

In addition to the foregoing, analysis engine 102 has the capability to utilize URLs that are discerned or extracted from incoming raw data to navigate to and/or browse both safe and unsafe sites indicated by the URLs. System 100 and/or analysis engine 102, in particular, typically does not possess the requisite infrastructure needed to detect or safeguard against inadvertent execution of malware encountered during traversal or navigation of indicated URLs. Thus, to militate against corruption of the system through inadvertent execution of, or infection by, encountered malware, analysis engine 102 can be configured to execute each encountered URL in separate or isolated partitions and/or sub-partitions when following indicated URLs to possible malware locations. These partitions and/or sub-partitions can thus periodically be reset and fresh images of each partition and/or sub partitions can be provided for continued operation.

System 100, through facilities provided by current database 104, archive database 108, and permanent database 110 can maintain at least three levels of databases to keep a comparatively minimal amount of data on which queries can be performed. In accordance with an embodiment, current database 104 can have a retention period of less than six months, archive database 108 can have a retention period of at least six months and less than twenty-four months, and permanent database 110 can have a retention period of at least twenty-four months or greater, for example. Typically, data that is generated from feed and job processing and/or analysis by analysis engine 102 can be stored in current database 104. Entries in current database 104 older than six months can be moved to archive database 108, thereby retaining only the latest six months data in current database 104, while records persisted in archive database 108 that are older than twenty-four months can be moved to permanent database 110. It will be noted in this regard, that in the case of referential records, (e.g., those records spread across more than six months duration that might be spread across current database 104, archive database 108, or permanent database 110), care must be taken to ensure that dependent records are not deleted on movement or merger of data from current database 104 to archive database 108 and/or archive database 108 to permanent database 110. The frequency or duration of movement or merger of data or records from current database 104 to archive database 108 and/or archive database 108 to permanent database 110 can be a configurable parameter. In accordance with various embodiments, the frequency or duration of movement of data or records from current database 104 to archive database 108, and from archive database 108 to permanent database 110 can be set to once a week, for instance. Nevertheless, other frequency periods (longer or shorter) can be selected without departing from the scope or intent of the subject application.

The results generated by analysis engine 102 can be reports that can be formatted as an exportable spreadsheet in accordance with various embodiments. Thus, analysis engine 102 in conjunction with front end component 106 can provide an option that the report be exported as a spreadsheet with the associated raw data appended thereto. Further, in accordance with an embodiment, analysis engine 102 in concert with front end component 106 can provide an option that allows the query that produced a result set to be saved and/or included in the report. Such a facility can allow users of the system, on entering the same query, to retrieve the same or similar results when the query is re-entered at a time subsequent. Additionally, it will be noted that entered queries (e.g., queries entered by way of front end component 106) can be persisted for subsequent or future execution, processing, and/or analysis by analysis engine 102.

Queries entered via front end component 106 to analysis engine 102 for processing and/or analysis can have the following attributes: a time boundary or search horizon over which to limit the search; a job number or ticket number; a free text field the text entered therein being input that should be searched in the e-mail body or header; and an option (e.g., implemented by radio buttons or check boxes) that indicates whether the free text entered in the free text field should be applied against the e-mail body, the e-mail header, or both. Additionally, queries input into analysis engine 102 can also be employed to search contents of web pages and/or hypertext transfer protocol (HTTP) headers.

Analysis engine 102 can generate or produce a multiplicity of disparate reports. In one case where analysis engine 102 generates a report that involves a trusted party (e.g., an established entity that develops, manufactures, licenses, and/or supports a wide range of legitimate products and services) being spammed by e-mails, analysis engine 102 can produce or generate, based on a timeline, reports that contain the following information: lists of all the URLs spammed via e-mail; lists of e-mail originating IPs; and lists of IP locations related to e-mails. Further, the report generated in the case where a trusted party is being spammed by e-mails can make available for download: related e-mails; related trusted party web pages; related target pages spammed by those trusted party web pages; related image snapshots; related URL page elements such as cookies, invalid secure sockets layer (SSL) or transport layer security (TLS) certificates, headers, robot.txt, etc.; and ancillary intelligence, obtained from facilities such as WHOIS (e.g., a query and response protocol used for querying databases that store the registered users or assignees of an Internet resource, such as a domain name, an IP address block), domain internet groper (DIG) (e.g., tool for querying domain name system (DNS) name servers for any desired DNS records), and tools that attempt to derive geographical data (country, region, city, latitude, longitude, ZIP code, time zone), internet service provider (ISP), and domain name, about an internet user using their IP addresses. Additionally, reports generated can also include heat maps that correlate and/or associate the foregoing information to show source attribution of an e-mail and/or the origination point of malware, spam, etc.

In a further instance where analysis engine 102 generates a report that involves e-mails indirectly related to target URLs via an intermediate page or multiple intermediate pages, analysis engine 102 can when provided an algorithm or desired list to attributes (e.g., a domain name or IP address if the URL does not include a domain) is able to return related spam e-mails even when apparently obfuscated by intermediate web pages. For instance, given a target top level domain (TLD), analysis engine 102 can search back to any potential intermediate page and track back to e-mails that spammed the intermediate page thereby revealing the direct links. In so doing, analysis engine 102 can generate a report that includes: lists of all URLs spammed by e-mails; lists of e-mail originating IPs; and lists of IP locations related to e-mails, for instance.

In addition, analysis engine 102 in various embodiments can also provide reports based on queries related to originating e-mail IP, DNS address record (A), DNS resource record (RR), e-mail MTA IP hops, DNS name server (NS) record, DNS start of authority (SOA) record, DNS mail exchange (MX) record, and the like. The report generated by analysis engine 102 can, for example, include: lists of all URLs spammed by e-mails; lists of e-mail originating IPs; and lists of IP locations related to e-mails. Furthermore, analysis engine 102 in another embodiment can generate reports based on queries related to top level domains (TLDs), country code top level domains (CCTLDs), generic top level domains (GTLDs), and the like. In accordance with this instance, analysis engine 102 can query: parsed out top level domains from URL web pages, parsed out top level domains from e-mail spammed URLs, parsed out top level domains from e-mail headers, parsed out top level domains from e-mail bodies, and parsed out top level domains from DNS RR (and NS, SOA, MX, and A records).

In accordance with further embodiments, analysis engine 102 can also determine what URLs have been spammed from a given TLD (CCTLD or GTLD) and in so doing analysis engine 102 can return a list of top level domains from e-mail spammed URL or domain, a list of top level domains from URL pages, and a list of top level domains from DNS RR NS. Additionally, in accordance with yet further embodiments, analysis engine 102 can effectuate queries against web page elements, e-mail attachments, or against any files captured by analysis engine 102 while visiting URLs.

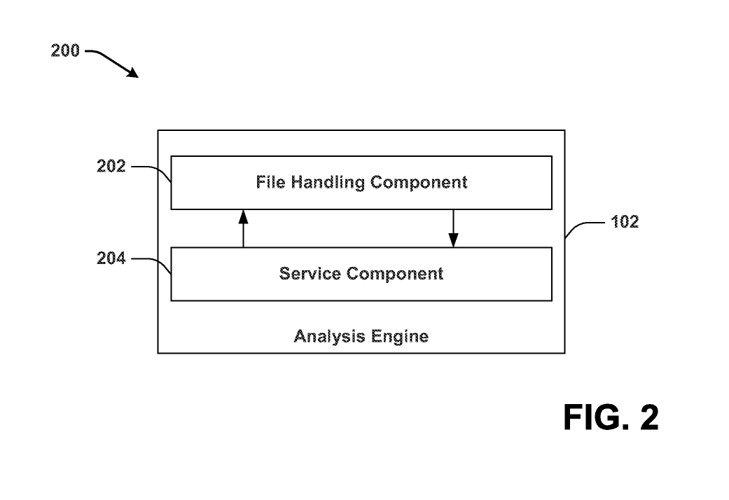

FIG. 2 provides further illustration of analysis engine 102, and more particularly, file handling component 202 and service component 204 that can be included within analysis engine 102. File handling component 202 and service component 204, operating in concert for example, can process and/or analyze incoming raw data, whether directly input into analysis engine 102 or supplied to analysis engine 102 by users via front end component 106, and thereafter generate reports as outlined above.

As illustrated, file handling component 202, without limitation or loss of generality, can process incoming raw data associated with at least the following file types: archival files (e.g., files with .zip file extensions), files with .msg file extensions (e.g., containing e-mail files), text files (e.g., files with .txt file extensions), and/or free text submitted via front end component 106. File types that are not recognized, generally are not immediately processed, but can be persisted, for instance, in one or more of the disclosed database aspects (e.g., current database 104, archive database 108, or current database 110) to await future processing (e.g., when file handling components addressing these unrecognized file types become available).

In the context of archival files (e.g., files with .zip file extensions), since archival files can themselves contain a panoply of files with both known or unknown file types, file handling component 202 can extract the files archived in the archival file identifying recognized files types (e.g., .msg, .txt, .zip, or free text) and thereafter processing recognized file types with an appropriate file handler. Thus, in accordance with one or more embodiments, file handing component 202 on extracting a file with a .msg file extension from an archival file can apply an appropriate message handler to solicit further intelligence from the .msg file. In accordance with further embodiments, file handling component 202 on extracting a file with a .txt file extension from an archival file can apply a file handler that can process and/or analyze text files. Similarly, in accordance with yet further embodiments, when file handling component 202 extracts files with a .zip file extension, it can utilize a file handler designed to cater to archival files.

While extracting archived files from an archival file, should file handling component 202 be unable to recognize a file type, file handling component 202 can persist these unknown or unrecognized file types to a repository such as current database 104, archive database 108, or permanent database 110. It should be noted in this regard, given the focus of this application in detecting malware, spam, and the like, that special isolation measures will typically need to be taken in order to sequester or quarantine files associated with unknown file types and/or of dubious provenance.

In the context of files with .msg file extensions, when file handling component 202 encounters files with .msg file extensions it can tokenize and store all the known fields in the e-mail header, and further can store the entire header in a full-text search capable field. Known e-mail header fields that can be tokenized and/or stored can typically include: all IP addresses, originating IP address, e-mail identifier (id) and/or display name, subject, date/time sent, date/time received, originating e-mail address, RFC 1918 private IP addresses, and the like. With regard to tokenizing and/or storing the e-mail id and/or display name, file handing component 202 can further tokenize and store information related to the Reply-To, ReturnPath, From, Sender, To, and/or CC fields.

Further, with respect to handling files with .msg file extensions, file handling component 202 can detect or identify the server hops from the e-mail header. File handling component 202 can accomplish this by identifying, persisting, and/or parsing mail transfer agent (MTA) hops included in the Received fields in the e-mail header, and enabling MTA IP addresses for utilization by GeoIP facilities as discussed infra.

Also with respect handling files with .msg file extensions, file handling component 202 can parse the e-mail body and store: all URLs (regardless of e-mail MIME type), all e-mail addresses, all domain names contained in e-mail addresses, all fully qualified domain names (FQDNs) contained in the URLs for employment by facilities provided by DIG and GeoIP services, all GTLD and CCTLD information for use by WHOIS facilities, and telephone numbers. Thereafter, file handling component 202 can store the entire e-mail body in one more full-text search capable fields.

Further, with regard to handling files with .msg file extensions, file handling component 202 can extract attachments and store: filenames, respective file size, and the following hashes of the attachments: cyclic redundancy check (CRC) or polynomial code checksum (a hash function typically employed to detect accidental changes to raw computer data, and commonly employed in digital networks and storage devices), message-digest algorithm 5 (MD5) (a cryptographic hash function typically with a 128-bit hash value generally utilized in security applications, and typically employed to check the integrity of files), and secure hash algorithm (SHA) (a cryptographic hash function with multiple variants (e.g., SHA-0, SHA-1, SHA-2, . . . ); SHA-1 is the most widely used of the existing SHA hash functions, and is generally employed in security applications and protocols). It should be noted, without limitation or loss of generality, due to the pernicious nature of extracted attachments, once the foregoing information has been extracted, the attachments can be deleted or expunged from the system.

In connection with files having .txt file extensions and/or free text entered or supplied by users through free text fields associated with front end component 106, file handling component 202 typically can process text files and free text entered or supplied by users once it has processed the e-mail body. In accordance with this aspect, file handling component 202 can also look for e-mail header-like content (e.g., From, To, CC, Bcc, Subject, etc) in the beginning of the supplied text or text under consideration. Moreover, when file handling component 202 identifies such e-mail header-like content, it can parse and/or store the individual field, as explicated above.

With regard to currently unknown or unrecognized file types, file handling component 202 in conjunction with front end component 106, can provide facilities and/or mechanisms to allow privileged users (e.g., administrator, etc.) the ability to plug-in components to process additional file types. These plug-in components can be implemented in the form of shared libraries. To provide for ease of use, file handling component 202 and front end component 106 can provide a web-interface that permits privileged users to configure a new additional file type and associate a plug-in component deemed capable of handling file processing on the file type. It should be noted without limitation or loss of generality in this regard however, that while the web interface will allow privileged users to associate additional file types with plug-in components capable of processing particular file types, uploading of the plug-in component itself will typically require the privileged user to actively copy the plug-in component from a security controlled development environment, for example, to the production environment, and thereafter require the privileged user to effectuate a restart of the system (e.g., system 100) in its entirety or affected portions of the production environment.

Service component 204 as illustrated can be a suite of components that can perform independent actions, such as WHOIS resolution, on data that has previously been persisted in one or more of current database 104, archive database 108, or permanent database 110, or that has contemporaneously or recently been processed by aspects of file handling component 202. Typically components included or associated with service component 204 can follow a common data point in order to learn the credentials necessary to connect to the database aspects (e.g., current database 104, archive database 108, or permanent database 110). Moreover, each of the components included or associated with service component 204 can be applied individually and/or in combination to raw data being fed into analysis engine 102. Further, the components included or associated with service component 204 typically do not have the capability to delete unless there were no feeds processed by a particular component until the deletion time. Additionally, privileged users of the system can have the ability to disable individual service components or the entirety of components associated with service component 204 on demand. However, it should be recognized without limitation or loss of generality that disabling individual services components or the totality of the components associated with service component 204 by privileged users will typically be effectuated after a time lag or on system restart, for example.

As has been described in connection with file handling component 202 and the addition of file handling components associated with file extensions of unknown attribution, service component 204 can have a similar facility. In this regard, service component 204 can provide privileged users the ability to add new service components once system 100 has been placed in service or is in operation. To facilitate this feature service component 204 together with front end component 106, for example, can provide the functionality to allow privileged users the ability to include additional service components to service component 204. These additional service components, like the plug-in file handling components elucidated above, can be implemented in the form of one or more shared libraries. Moreover, to ease the burden placed on the privileged user tasked with adding service components, service component 204 and front end component 106 can provide a web-interface that permits privileged users to configure and/or associate newly added service components.

Typically, service component 204 can maintain white lists (e.g., lists of items for which processing is not required) for each individual service component included within service component 204. It nevertheless should be noted, without limitation or loss of generality, that while service component 204 can maintain respective white lists for each and every service component extant within service component 204, each white list is generally confined to being operable with the service to which it is associated. Thus, for instance, a white list associated with the WHOIS facility is typically restricted to use by the WHOIS facility. Similarly, a white list associated with the DIG service is generally confined to operation with the DIG service. Generally each white list associated with individual services effectuated by service component 204 can include information related to: sender domain, sender e-mail identifier, recipient e-mail identifier, recipient domain, URLs, FQDNs, GTLDs, CCTLDs, etc. Thus in an implementation, for instance, where a sender's domain appears in a white list associated with a particular service included in service component 204, when the service peruses its associated white list it can be forewarned to desist from processing e-mails sent from this particular domain regardless of sender.

Service component 204 in implementing operation of each individual service included therein can impose a priority or order in applying services to feed data. Generally, service component 204 can ensure that input supplied as manual input (e.g., received by way of front end component 106) can be serviced first, and thereafter can ensure that the latest items from the automatic feeds are subsequently handled.

Service component 204, as discussed below, can typically provide the following services: geographical location to IP address information translations wherein either an IP address is correlated to a geographical location or a geographical location is translated into an IP address (e.g., GeoIP), facilities for query domain name system (DNS) name servers for associated DNS records (e.g., DIG), mechanisms for querying repositories that store the registered users or assignees of an internet resource, such as a domain name, an IP address block, or an autonomous system (e.g., WHOIS), and protocols that read and browse URLs in order to perform listed or enumerated actions (e.g., a web capture service).

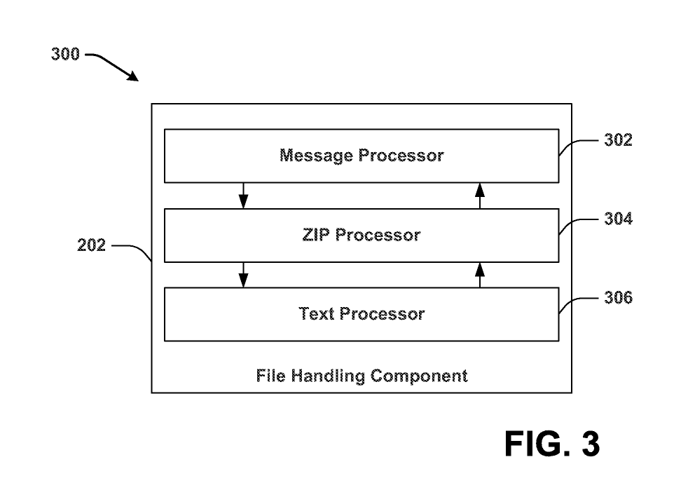

FIG. 3 provides further depiction of file handling component 202 in accordance with various embodiments of the application. As stated above, file handling component 202 can process incoming raw data associated with multifarious file types or affiliated with diverse file extensions, such as archival files (e.g., files with .zip file extensions), files associated with e-mail (e.g., files with .msg file extensions), text files (e.g., files with .txt file extensions, or free text entered by users through facilities provided by front end component 106. Moreover, as stated supra, file types or files with unrecognized file extensions can be persisted for future analysis and/or processing once file handling components and/or capabilities have been developed to address these unrecognized file type or file extensions.

Accordingly, file handling component 202 can comprise message processor 302 that can be tasked with analyzing and/or processing files associated with e-mails (e.g., files associated with .msg file extensions). Message processor 302 on receipt of a file with a .msg file extension can open the file and tokenize and store all the known or identifiable fields in the e-mail header and thereafter can store these fields in a text searchable format. Fields that are currently known to be identifiable within e-mail headers include IP addresses, e-mail id and/or display name, subject, date/time received, originating IP address, originating e-mail address, private IP addresses, and the like. Additionally, message processor can also tokenize and persist information related to other associated fields such as Reply-To, ReturnPath, From, Sender, To, and/or CC fields.

Message processor 302 can also utilize information included in the e-mail header to detect the server hops by identifying, persisting, and/or parsing the MTA hops included in the Received fields in the e-mail header, thereby enabling MTA IP addresses for use by services that provide geographical location to IP address information translations.

Additionally, message processor 302 can parse the e-mail body and thereafter persist all URLs (regardless of e-mail MIME type), all e-mail addresses, all domain names contained in e-mail addresses, all FQDNs contained in the URLs for employment by facilities provided by services such as DIG and/or GeoIP, all GTLD and CCTLD information for use by services such as WHOIS, as well as telephone numbers if such information is available. Once message processor 302 has obtained this information, partially or in full, message processor 302 can persist the entire e-mail body in its entirety in a full-text searchable format.

Message processor 302 can also scrutinize e-mails in order to extract and store attachments that have been included in e-mails under scrutiny. In facilitating this objective, message processor 302 can extract file names, information relating the file size, and can apply various hash policies, such as CRC or polynomial code checksum, MD5, SHA-1, or SHA-255, and the like, to both the e-mails and/or the attachments to elicit further intelligence regarding an e-mail at issue. Once message processor 302 has completed extracting and storing information contained in the attachments, given the possible insidious nature of these attachments, it can place the attachments in quarantine or initiate deletion of the attachments from the system.

Further, file handling component 202 can also include zip processor 304 that can analyze and/or process archival files (e.g., aggregation of files ensconced within files associated with .zip file extensions, wherein each aggregation of files can possibly include files with disparate file extensions). Zip processor 304 on receipt of archival files can extract the files archived in the received archival file, identify recognized file types (e.g., .msg, .txt, .zip) and thereafter can direct these recognized file types to an appropriate processor (e.g., message processor 302 and/or text processor 306) for further analysis and/or processing. Thus, for instance, where zip processor 304 encounters files with .msg file extensions, zip processor 304 can send the files to message processor 302. Similarly, where zip processor 304 encounters files with .txt file extensions, zip processor 304 can forward the files to text processor 306. Further, given that archival files themselves can include additional archival files, zip processor 304 can recursively extract the files included in these additional archival files and direct files with recognized file extensions to appropriate processors for analysis and/or processing. It should be noted that where zip processor 304 is unable to identify a file type or file extension it can store these unrecognized files in a repository, such as current database 104, archive database 108, permanent database 110, or preferably to some alternate persisting modality isolated from system 100.

Additionally, file handling component 202 can include text processor 306 that can be employed to analyze and/or process text files (or free text entered by users through front end component 106). Similar to the processing performed by message processor 302, text processor 306 can parse the text file identifying URLs, e-mail addresses, domain names, FQDNs contained in the URLs, GTLD and CCTLD information, or telephone numbers contained in the text file. Further, text processor 306 can also scan and parse the text file for e-mail header-like content (e.g., fields such as To, From, CC, BCC, Subject, etc.) that typically can exist at the beginning of the text file. Once text processor 306 has been able to extract such information from the text file, it can store the information in individual fields.

In a similar fashion, text processor 306 can also process free text that can have been entered (e.g., copied and pasted) by users in free form text fields generated and provided by front end component 106. As described above, text processor 306, in this instance, can parse the free form text identifying URLs, e-mail addresses, domain names, FQDNs, TLD, GTLD, and CCTLD information, e-mail header-like content, etc. contained therein and thereafter can persist this information in searchable text fields.

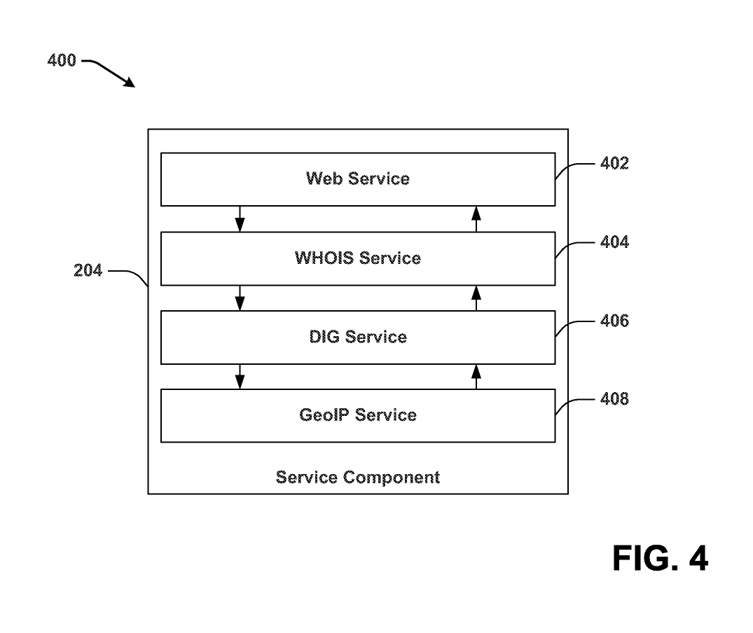

FIG. 4 is a block diagram that further illustrates aspects of service component 204 in accordance with various described embodiments. As depicted in FIG. 4, service component 204 can include a web service 402 that can read and browse URLs identified by aspects of file handing component 202 and can perform actions based on the identified URLs. In particular, web service 402 can perform web operations with the identified URLs and where or when a URL is unreachable, web service 402 can identify it for a subsequent attempt.

Web service 402, based at least in part on whether the URL is associated with either a trusted or a non-trusted party, can perform, depending on whether the URL is affiliated with a trusted party or a non-trusted party, a selective series of actions in order to detect various forms of redirection that typically are employed by purveyors of malware to obfuscate the origination point of the malware. Where the URL is associated with a non-trusted party (e.g., a party not previously ascertained as being trustworthy or a party not identified in a supplied white list) web service 402 can take actions to visit the URL and can detect the following forms of redirection and can store the order of redirection for later reporting: HTTP 3xx redirection codes (e.g., HTTP 300, HTTP 301, HTTP 302, etc.), HTML <meta> tag with refresh to non-self page (e.g., do not process the refresh which refreshes to the same page), redirects employing client-side scripting, or redirects utilizing cascading style sheets (css). Further, in the context of URLs associated with non-trusted parties, web service 402 can capture snapshots (e.g., in jpeg format) of all intermediate web pages through which traversal is made while following a URL, store HTTP headers as full text, capture snapshots of the final page, save the final page in an web page archive format (e.g., .mht files) that combines resources that are typically represented by external links together with HTML code, and store the final page as HTML.

Where the URL is associated with a trusted party, web service 402 can perform the same or similar actions as enumerated for non-trusted parties, but in addition web service 402 can also parse files saved in a web page archival format to identify URLs associated with non-trusted parties and store all non-trusted party URLs, FQDNs, CCTLDs, GTLDs, etc, for further processing. Moreover in the context of URLs associated with trusted parties, web service 402 can also download all the individual files in the web page to a local folder, determine the hashes (e.g., MD5, SHA-1, SHA-256, etc.) of the files downloaded and store the hashes to the database aspects elucidate above (e.g., current database 104, archive database 108, or permanent database 110).

Further, service component 204 can also include WHOIS service 404 that can be utilized to resolve GTLD and/or CCTLD entries that can have been ascertained during contemporaneous or prior processing by the components included with file handling component 202. In order to accomplish this WHOIS service 404 can query all available WHOIS data or records, such as registrant, administrative contact, technical contact, organization, and the like, associated with a particular FQDN. Additionally, WHOIS service 404 can also perform reverse WHOIS queries wherein an IP address (rather than a FQDN) is employed to gain access to the WHOIS data or records. Typically, when WHOIS service 404 is invoked it can be employed to resolve GTLD and/or CCTLD entries to registration information. Nonetheless, there can be instances where a particular GTLD or CCTLD is not resolvable. In these cases WHOIS service 404 can mark such GTLDs or CCTLDs for resolution at a later time.

Service component 204 can additionally include DIG service 406 that can be employed to query domain name system (DNS) name servers for any desired DNS records. The DIG service 406 can resolve FQDNs to DIG data by querying the DNS name service associated with a FQDN, previously or contemporaneously identified during processing or analysis by aspects of file handling component 202, in order to retrieve DNS records associated with the FQDN. Where DIG service 406 is incapable of resolving a FQDN, it can be marked for a subsequent resolution by DIG service 406.

Further, service component 204 can also provide a GeoIP service 408 that can be utilized for geographical location to IP address information translations wherein either an IP address is correlated to a geographical location or a geographical location is translated into an IP address. GeoIP service 408 typically can be employed to resolve the IP to geographical location data associated with a particular IP address identified during prior processing or analysis of file handling component 202, or aspects thereof. GeoIP service 408 can persist the IP address to geographical location data and/or geographical location data to IP address revealed during processing. Since the correlation between an IP address and geographical location can very over time (e.g., since disseminators of malware typically can be extremely mobile, moving between several geographical locations with alacrity), each IP address to geographical location or geographical location to IP address association can be stored against the source (e.g., the feed: automatic or manual) that elicited the correlation.

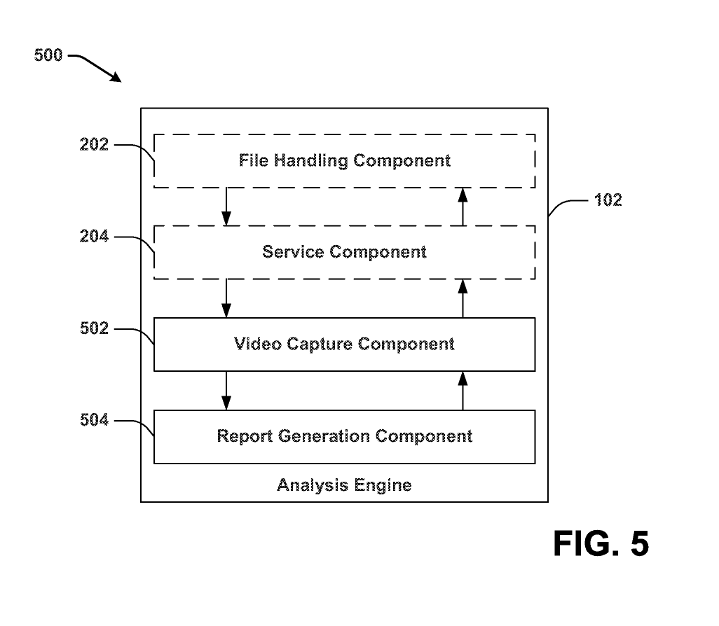

FIG. 5 shows analysis engine 102 in additional detail. As depicted analysis engine 102, in addition to the file handing component 202 and service component 204, the facilities and functionalities of which have been discussed above in relation to FIGS. 2-4, can include video capture component 502 that can be utilized to maintain a video record of the operation of each of file handling component 202 and/or service component 204, and sub-components respectively included therein, as they execute their particular processing tasks, such as traversing the digital trail (e.g., chains of URLs constructed using the functionalities provided by file handling component 202 and service component 204) leading from a source spam e-mail advertising malware, for instance, to the origination or dissemination point of the malware, for example. Such video records can be particularly useful for the purpose of prosecution of disseminators of malware.

Additionally, analysis engine 102 can further include report generation component 504 that can be utilized to create a multiplicity of disparate reports and/or diverse heat maps utilizing the information marshaled utilizing the facilities and functionalities provided by file handling component 202 and/or service component 204. Reports created by report generation component 504 can be generated in an exportable spreadsheet format, wherein the raw data and/or queries that were employed to produce the resultant report can also be appended or included in the report. Further, report generation component 504 can produce reports based on a timeline which can include lists of all the URLs spammed via e-mail; lists of e-mail originating IP addresses; or lists of geographical location to IP address correlations. Report generation component 504 can additionally make available for download any related e-mails; related web pages; target pages spammed by the related web pages, related image snapshots in JPEG format, for example; related URL page elements, such as cookies, invalid SSL or TLS certificates, or the like; and ancillary intelligence marshaled through utilization of the services provided by service component 204.

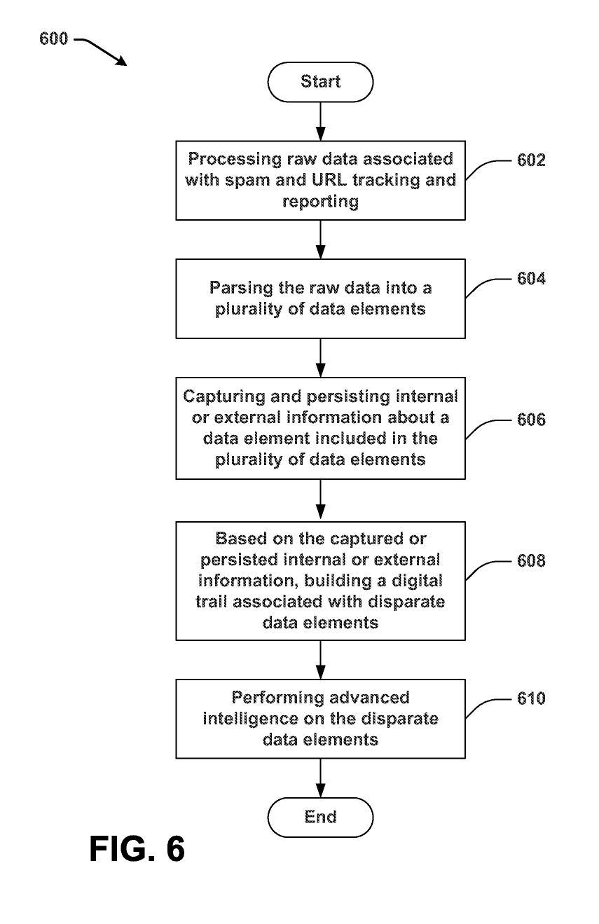

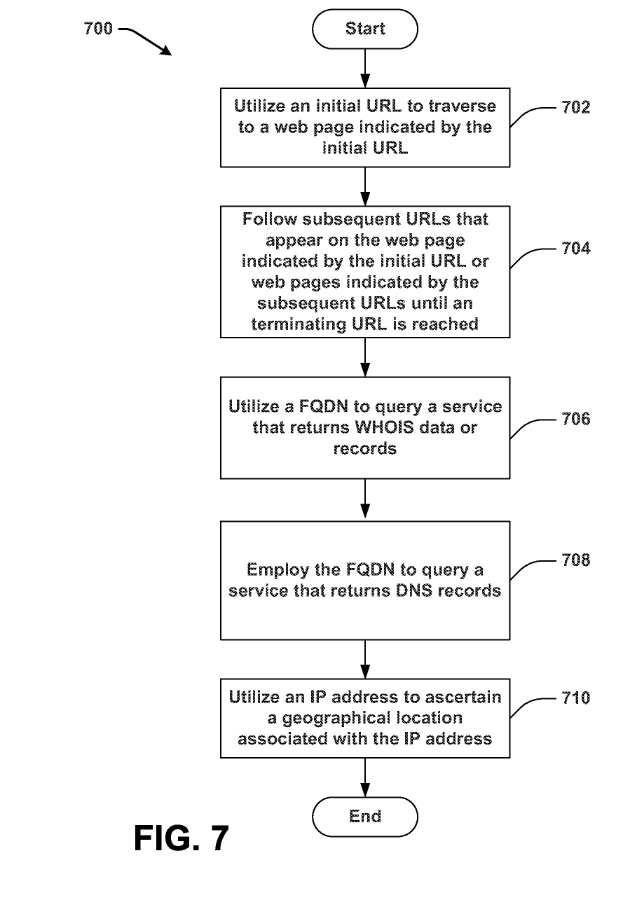

In view of the illustrative systems shown and described supra, methodologies that may be implemented in accordance with the disclosed subject matter will be better appreciated with reference to the flow charts of FIGS. 6 and 7. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring of such methodologies to computers.

One or more embodiments of the subject disclosure can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 6 illustrates a flow diagram of a machine or computer implemented method 600 that effectuates and/or facilitates spam tracking and uniform resource locator (URL) analysis reporting. Method 600 can commence at 602 where raw data associated with spam or URLs received in e-mails can be processed. At 604 the received raw data can be parsed into a plurality of data elements, such data elements can include all URLs included in an e-mail; originating IP addresses associated with an e-mail and extant in an e-mail header; e-mail IDs and display names included with an e-mail; attributes such as Reply-To, ReturnPath, From, Sender, To, Cc, and Bcc fields included in the e-mail header; details such as Subject, DateTime Sent, DateTime Received, originating e-mail addresses, etc. Further, at 604 the e-mail body can be parsed to extract all: URLs (regardless of e-mail MIME type), e-mail addresses, domains contained in e-mail addresses, FQDNs contained in the URLs for use by the DIG and/or GeoIP facilities, GTLD and CCTLD for use by the WHOIS component, and telephone numbers. Additionally at 604, attachments included in an e-mail can be extracted and details such as file names, file size, and hashes of the attachments noted. The parsed and/or extracted data elements can then be persisted and/or further processed.

At 606 through use of functionalities provided by the aforementioned web service, WHOIS service, DIG service, and/or GeoIP service, and the data elements employed individually and/or in combination additional internal and/or external intelligence or information can be captured or elicited. Such additional internal and/or external information can include geographical location of a particular IP address, information regarding the DNS name server associated with a FQDN, and other pertinent information related to the registrant, etc. of a particular domain. This additional internal and/or external intelligence can be persisted to database (e.g., current database 104, archive database 108, permanent database 110, or some alternative persisting device).

At 608 the captured internal and/or external intelligence can be utilized to build a digital trail wherein each data element is employed in combination with the captured internal and/or external intelligence to weave a digital trail that can lead from a received spam e-mail, though one or more affiliate sites, and ultimately to the originator of the spam e-mail. Thereafter, at 610 further advanced intelligence, e.g., through use of the web service, WHOIS service, DIG service, and/of GeoIP service and the disparate data elements can be carried out to elicit yet further information regarding the originators of the spam e-mail and their affiliates.

FIG. 7 provides illustration of a further flow diagram of a machine or computer implemented method 700 that effectuates and/or facilitates spam tracking and uniform resource locator (URL) analysis reporting. Method 700 can commence at 702 wherein an initial URL obtained parsed and/or tokenized from the e-mail body of an e-mail included in incoming raw data is utilized to traverse to the web page indicated by the initial URL. At 704, on arriving or gaining access to the web page indicated by the initial URL, the method can scan the web page to identify further or subsequent URLs, and thereafter can follow these further or subsequent URLs to gain access the web pages associated with these further or subsequent URLs. At 704 it should be noted that the method can repeat the process of scanning the web page identified by the initial URL or web pages associated with subsequently accessed URLs and following these URLs until such time that a terminating URL (e.g., a URL that points to a web page where no further URLs are presented) is reached. While at 704 details such as IP address, FQDNs, and the like, can be used during current processing and/or persisted for future use.

At 706 a FQDN associated with an e-mail included in incoming raw data can be utilized to query a service that returns WHOIS data or records. Thus based at least in part on the FQDN, information related to the e-mail, such as registrant, administrative contact, technical contact, organization, etc. can be returned for subsequent use.

At 708 the FQDN associated the e-mail can also be employed to query a service that returns related DNS records. Thus, for instance, originating e-mail IP addresses, DNS address records (A), DNS resource records (RR), mail transfer agent (MTA) IP hops, DNS name server (NS) records, DNS mail exchange (MX) records, and the like, can be obtained or returned. These records can be contemporaneously utilized and/or can be persisted for future use. At 710 IP addresses (e.g., originating e-mail IP addresses) associated with the e-mail can be used to ascertain a geographical location from where the e-mail address emanated from.

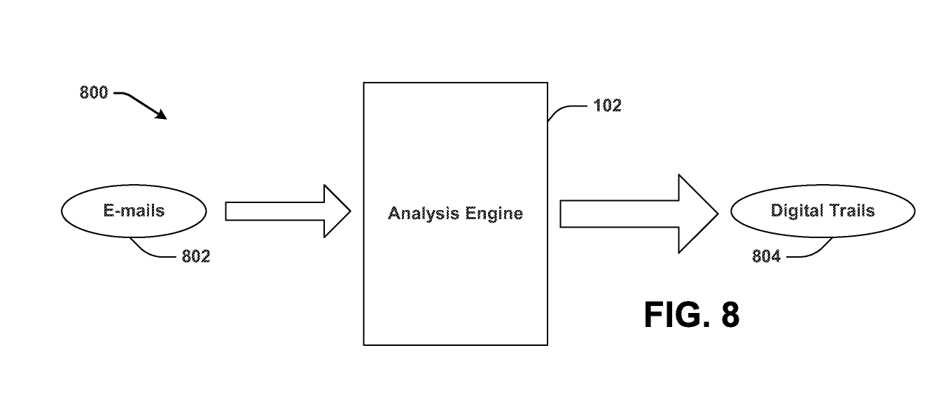

FIG. 8 is a further block diagram depicting a system 800 that effectuates spam tracking analysis reporting. As illustrated, system 800 includes analysis engine 102 that receives a plurality of e-mails 802 contained in raw data associated with spam and URL tracking and reporting, processes the incoming e-mails 802 included in raw data, and builds or constructs one or more digital trails 804 associated with the plurality of incoming e-mails 802. Analysis engine 102 accomplishes processing of incoming e-mails 802 and constructing one or more resultant digital trails 804 by parsing the raw data containing the plurality of emails 802 into a plurality of data elements and tokenizing at least one of the e-mail header, the e-mail body, or attachments associated with the incoming e-mails 802 into further data elements. Additionally, analysis engine 802 can parse and tokenize the e-mail files to ascertain originating e-mail IP addresses, DNS address records, DNS resource records, the number of e-mail transfer agent IP hops, DNS name server records, DNS start of authority records, or DNS mail exchange records, for example. Further, analysis engine 102 can also parse and tokenize text files, that can also be included in the incoming steams of raw data, wherein any and all URLs, internet protocol (IP) addresses, sender domains, sender e-mail identifiers, recipient e-mail identifiers, recipient domains, FQDNs, top level domains (TLDs), generic top level domains (GTLDs), or country code top level domains (CCTLDs) can be identified.

Analysis engine 102 further accomplishes processing of incoming e-mails 802 and constructing one or more resultant digital trails 804 by capturing and/or persisting internal or external information about each data element wherein the external and/or internal information relates to registration information, such as registrant information, organization information, administrative contact information, and the like. Further, analysis engine 102 in capturing and/or persisting internal and/or external information employ data elements to determine a geographic location from where the e-mails emanated, and further utilize the data elements to obtain DNS records associated with the data elements and ascertain the number of server hops between an originating point of a particular e-mail and the destination point of the e-mail at issue.

Analysis engine 102 can thereafter employ the elicited and/or ascertained internal and/or external information to build or construct a digital trail by visiting and maintaining a video record of each URL identified during prior processing. It will be appreciated by those moderately conversant in this field of endeavor that analysis engine 102 as it visits each URL associated with a particular web page that it can identify further URLs that appear on the visited web page and can follow these further URLs until such time as no further URLs appear on a further visited web page. It is at this time that analysis engine 102 can identify whether or not the terminating web page (e.g., a web page that presents no further URLs) contains malware, such as rogue security software, for instance.

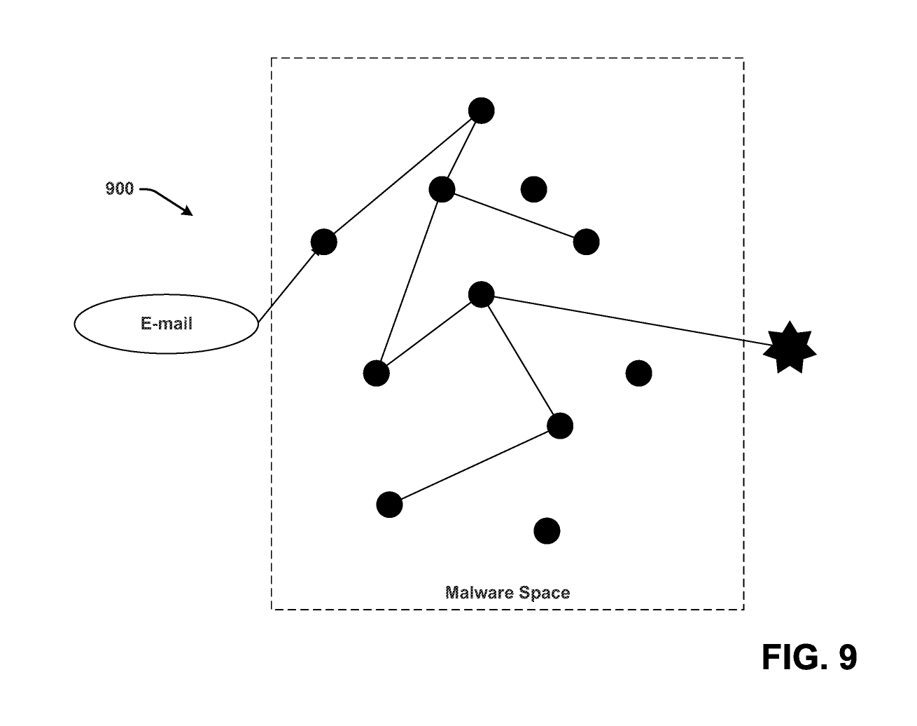

FIG. 9 provides depiction of an illustrative digital trail 900 constructed by the spam tracking analysis reporting system. As depicted, digital trail 900 leads from an e-mail identified as spam, through multiple intermediary or affiliate web sites (depicted as black dots existing in malware space), and ultimately to a spam disseminator depicted as a seven pointed star. This digital trail can be used for legal purposes to illustrate the connections between spam emails and the disseminators of spam and their associates or affiliates.

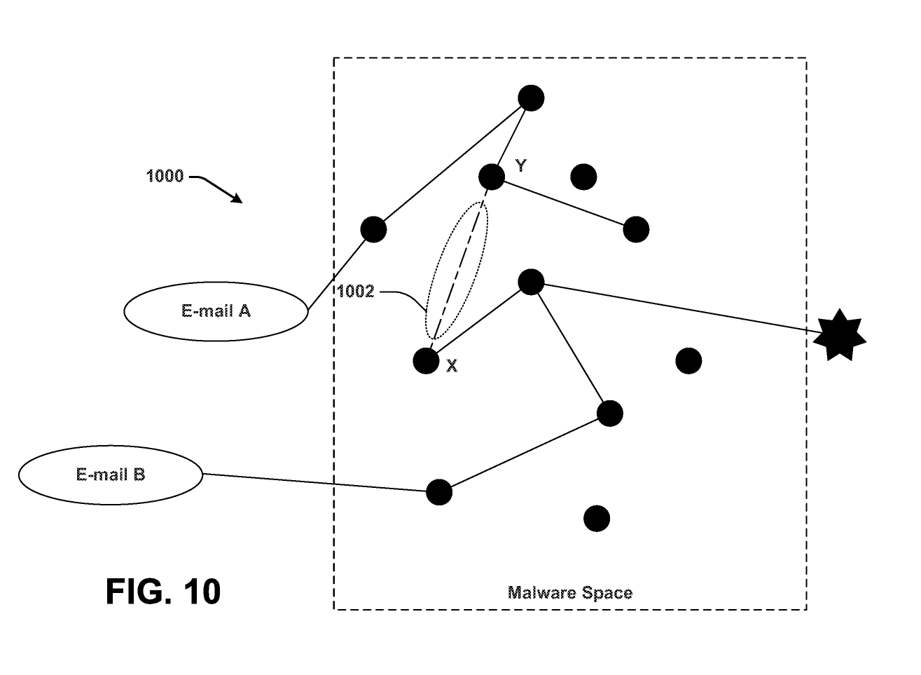

FIG. 10 is a further illustration of a digital trail 1000 generated by the spam tracking analysis reporting system. FIG. 10 illustrates the establishing of the digital trail depicted in FIG. 9. In FIG. 10 two e-mails are shown, e-mail A—an e-mail that has been recently been analyzed and processed, and e-mail B—an e-mail that was previously processed. It will be observed that e-mail A on its own does not terminate at the spam disseminator depicted as a seven pointed star. Thus, if e-mail A had been processed by analysis engine 102 as the sole e-mail, analysis engine 102 would not have reached the spam disseminator, but would have terminated at an intermediate affiliate resident in malware space. However, analysis engine 102, through utilization of information previously captured and persisted with respect to e-mail B, can establish a linkage 1002 associating the intermediate affiliate X identified in the analysis of e-mail B with the intermediate affiliate Y identified during the processing and analysis of e-mail A. In this manner, analysis engine 102 can cascade associations and tie together e-mails, some of which may not have yielded conclusive results, to attribute spam received in e-mail A and e-mail B to a particular disseminator of spam.

The various embodiments herein can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the various embodiments as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the various embodiments.

Furthermore, all or portions of one or more embodiments described herein may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the various embodiments.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

One of ordinary skill in the art can appreciate that the various embodiments of methods and devices for a trusted cloud services framework and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

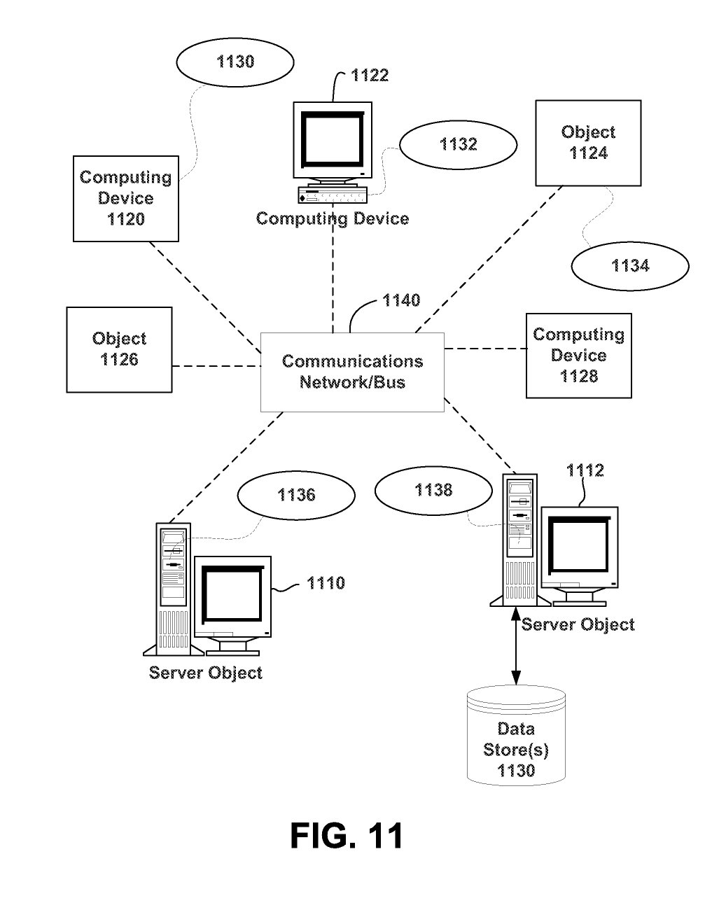

FIG. 11 provides a non-limiting schematic diagram of an exemplary networked or distributed computing environment. The distributed computing environment comprises computing objects 1110, 1112, etc. and computing objects or devices 1120, 1122, 1124, 1126, 1128, etc., which may include programs, methods, data stores, programmable logic, etc., as represented by applications 1130, 1132, 1134, 1136, 1138. It can be appreciated that objects 1110, 1112, etc. and computing objects or devices 1120, 1122, 1124, 1126, 1128, etc. may comprise different devices, such as PDAs, audio/video devices, mobile phones, MP3 players, laptops, etc.

Each object 1110, 1112, etc. and computing objects or devices 1120, 1122, 1124, 1126, 1128, etc. can communicate with one or more other objects 1110, 1112, etc. and computing objects or devices 1120, 1122, 1124, 1126, 1128, etc. by way of the communications network 1140, either directly or indirectly. Even though illustrated as a single element in FIG. 11, network 1140 may comprise other computing objects and computing devices that provide services to the system of FIG. 11, and/or may represent multiple interconnected networks, which are not shown. Each object 1110, 1112, etc. or 1120, 1122, 1124, 1126, 1128, etc. can also contain an application, such as applications 1130, 1132, 1134, 1136, 1138, that might make use of an API, or other object, software, firmware and/or hardware, suitable for communication with or implementation of a trusted cloud computing service or application as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 11, as a non-limiting example, computers 1120, 1122, 1124, 1126, 1128, etc. can be thought of as clients and computers 1110, 1112, etc. can be thought of as servers where servers 1110, 1112, etc. provide data services, such as receiving data from client computers 1120, 1122, 1124, 1126, 1128, etc., storing of data, processing of data, transmitting data to client computers 1120, 1122, 1124, 1126, 1128, etc., although any computer can be considered a client, a server, or both, depending on the circumstances. Any of these computing devices may be processing data, or requesting services or tasks that may implicate the improved user profiling and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1140 is the Internet, for example, the servers 1110, 1112, etc. can be Web servers with which the clients 1120, 1122, 1124, 1126, 1128, etc. communicate via any of a number of known protocols, such as the hypertext transfer protocol (HTTP). Servers 1110, 1112, etc. may also serve as clients 1120, 1122, 1124, 1126, 1128, etc., as may be characteristic of a distributed computing environment.

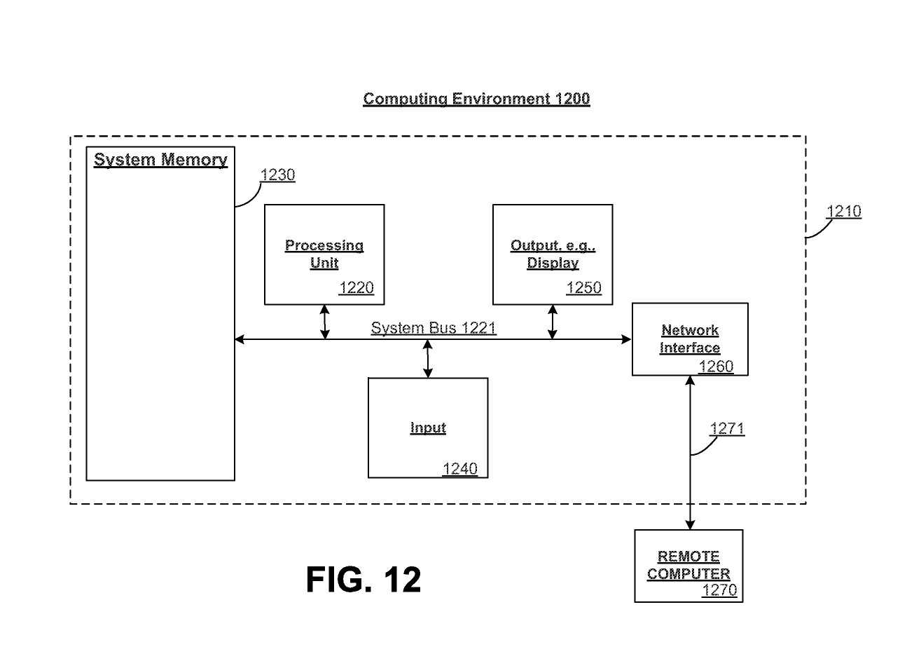

As mentioned, various embodiments described herein apply to any device wherein it may be desirable to implement one or pieces of a trusted cloud services framework. It should be understood, therefore, that handheld, portable and other computing devices and computing objects of all kinds are contemplated for use in connection with the various embodiments described herein, i.e., anywhere that a device may provide some functionality in connection with a trusted cloud services framework. Accordingly, the below general purpose remote computer described below in FIG. 12 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 12 thus illustrates an example of a suitable computing system environment 1200 in which one or more of the embodiments may be implemented, although as made clear above, the computing system environment 1200 is only one example of a suitable computing environment and is not intended to suggest any limitation as to the scope of use or functionality of any of the embodiments. Neither should the computing environment 1200 be interpreted as having any dependency or requirement relating to any one or combination of components illustrated in the exemplary operating environment 1200.

With reference to FIG. 12, an exemplary remote device for implementing one or more embodiments herein can include a general purpose computing device in the form of a handheld computer 1210. Components of handheld computer 1210 may include, but are not limited to, a processing unit 1220, a system memory 1230, and a system bus 1221 that couples various system components including the system memory to the processing unit 1220.

Computer 1210 typically includes a variety of computer readable media and can be any available media that can be accessed by computer 1210. The system memory 1230 may include computer storage media in the form of volatile and/or nonvolatile memory such as read only memory (ROM) and/or random access memory (RAM). By way of example, and not limitation, memory 1230 may also include an operating system, application programs, other program modules, and program data.

A user may enter commands and information into the computer 1210 through input devices 1240. A monitor or other type of display device is also connected to the system bus 1221 via an interface, such as output interface 1250. In addition to a monitor, computers may also include other peripheral output devices such as speakers and a printer, which may be connected through output interface 1250.

The computer 1210 may operate in a networked or distributed environment using logical connections to one or more other remote computers, such as remote computer 1270. The remote computer 1270 may be a personal computer, a server, a router, a network PC, a peer device or other common network node, or any other remote media consumption or transmission device, and may include any or all of the elements described above relative to the computer 1210. The logical connections depicted in FIG. 12 include a network 1271, such local area network (LAN) or a wide area network (WAN), but may also include other networks/buses. Such networking environments are commonplace in homes, offices, enterprise-wide computer networks, intranets and the Internet.

What has been described above includes examples of the disclosed subject matter. It is, of course, not possible to describe every conceivable combination of components and/or methodologies, but one of ordinary skill in the art may recognize that many further combinations and permutations are possible. Accordingly, the various embodiments described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method performed at least in part on at least one processor, comprising:
processing raw data associated with spam or URL tracking and reporting;
parsing the raw data into a plurality of data elements;
capturing and persisting internal and external information about a data element of the plurality of data elements; and
based on the internal and external information, building a digital trail associated with the plurality of data elements.

2. The method of claim 1, wherein the parsing of the raw data into the plurality of data elements further comprises tokenizing at least one of an e-mail header, an e-mail body, or an attachment of an e-mail into the plurality of data elements.

3. The method of claim 1, wherein the capturing and persisting further comprises querying databases that store registration information associated with the plurality of data elements, wherein the registration information includes at least one of a registrant entry, an organization entry, an administrative contact entry, or a technical contact entry.

4. The method of claim 1, wherein the capturing and persisting further comprises resolving a geographical location associated the plurality of data elements.

5. The method of claim 1, wherein the capturing and persisting further comprises querying a Domain Name Service (DNS) name server for DNS records associated with the plurality of data elements.

6. The method of claim 1, wherein the building of the digital trail further comprises visiting each URL included in an e-mail body, wherein the digital trail leads from a source e-mail included in the raw data to a destination web-page that contains rogue security software.

7. The method of claim 6, wherein the building of the digital trail includes maintaining a video record of the visiting.

8. The method of claim 1, wherein the capturing and persisting further comprises ascertaining, from mail transfer agent (MTA) hops included in an e-mail header, a number of server hops between an originating point of an e-mail associated with the e-mail header and a destination point of the e-mail associated with the e-mail header.

9. A system, comprising:
an analysis engine that parses and tokenizes raw data into a plurality of data elements, wherein the analysis engine employs the plurality of data elements to capture internal and external information about a data element included in the plurality of data elements, and builds a digital trail to an origination point of an e-mail included in the raw data based on the internal and external information.

10. The system of claim 9, wherein the raw data includes one or more of archival files, e-mail files, text files, or text manually entered in a free text field generated by a front end component.

11. The system of claim 10, wherein the analysis engine parses and tokenizes the text files to identify a uniform resource locator (URL), an internet protocol (IP) address, a sender domain, a sender e-mail identifier, a recipient e-mail identifier, a recipient domain, a fully qualified domain name (FQDN), a top level domain (TLD), a generic top level domain (GTLD), or a country code top level domain (CCTLD).

12. The system of claim 11, wherein the analysis engine, based on the top level domain (TLD), searches back to an intermediate page and tracks back to a previous e-mail that spammed the intermediate page to reveal a direct link between the text files and the previous e-mail.

13. The system of claim 11, wherein the analysis engine, based on the URL, detects one or more hypertext transfer protocol (HTTP) redirection.

14. The system of claim 10, wherein the analysis engine parses and tokenizes the e-mail files to ascertain at least one of an originating e-mail internet protocol (IP) address, a domain name service (DNS) address record (A), a DNS resource record (RR), a number of e-mail mail transfer agent (MTA) IP hops, a DNS name server (NS) record, a DNS start of authority (SOA) record, or a DNS mail exchange (MX) record.

15. The system of claim 14, wherein the analysis engine utilizes the originating e-mail IP address and a GeoIP component to resolve the origination e-mail IP address to a geographical location.

16. The system of claim 10, wherein the analysis component employs the FQDN and a WHOIS component to obtain registrant, administrative contact, technical contact, and organization information associated with the FQDN.

17. The system of claim 9, wherein the analysis engine maintains a video record of the internal and external information employed when traversing to the origination point of the e-mail.

18. A system, comprising:
an analysis engine that builds a digital trail based on internal or external information associated with a plurality of data elements parsed and tokenized from raw data that includes archival files, e-mail files, or text files, wherein the digital trail leads to an origination point associated with the plurality of data elements.

19. The system of claim 18, wherein the analysis engine when building the digital trail employs an initial uniform resource locator (URL) included in an e-mail body to traverse to further uniform resource locators (URLs) linked to the initial URL.

20. The system of claim 19, wherein the analysis engine when building the digital trail employs a video capture component that persists traversal from the initial URL to the further URLs, wherein the traversal from the initial URL to the further URLs forms the digital trail.
